(19) United States
(12) Patent Application Publication
(10) Pub. No.: US 2005/0219124 A1
(43) Pub. Date: Oct. 6, 2005

(54) Miniaturized multiband antenna

(75) Inventors: Nora Brambilla, Milano (IT); Achim Hilgers, Alsdorf (DE); Heiko Pelzer, Erkelenz (DE); Rainer Pietig, Aachen (DE); Thomas Purr, Munchen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/517,689

(22) PCT Filed: Jun. 11, 2003
(86) PCT No.: PCT/IB03/02224

§ 371 Date: Dec. 10, 2004

(30) Foreign Application Priority Data
Jun. 15, 2002 (DE) 102 26 794.4

(51) Int. Cl. H01Q 1/38

(52) U.S. Cl. 343/700 MS

(57) ABSTRACT

The invention relates to an antenna comprising a dielectric substrate (1) and two resonant printed wiring structures, more particularly for use in high-frequency and microwave domain. On an end face of the structure (2) is arranged along a first edge and on an opposite, second edge of the same end face a second printed wiring structure (3). The arrangement of the printed wiring structures provides that resonances are developed which make the use of the proposed antennas in the four separate GPS, DCS/PCS, UMTS and Bluetooth applications possible.

The invention relates to an antenna comprising a substrate having at least one resonant printed wiring structure, more particularly for mobile dual or multiband telecommunication sets such as mobile and cordless telephones, as well as appliances communicating according to the Bluetooth standard. The invention further relates to a circuit board with such an antenna as well as a radio communication device having such an antenna.

In mobile telecommunication, electromagnetic waves in the microwave domain are used for transmitting information. Examples for this are the mobile telephone standards in the frequency ranges from 890 (880) to 960 MHz (GSM900), from 1710 to 1880 MHz (GSM1800- or DCS), as well as from 1850 to 1990 MHz (GSM1900 or PCS), further the UMTS band (1885 to 2200 MHz), the DECT standard for cordless telephones in the frequency range from 1880 to 1900 MHz, as well as the Bluetooth standard in the frequency range from 2400 to 2480 MHz, which serve to exchange data between various electronic devices such as, for example, mobile telephones, computers, entertainment electronic appliances etc. Besides the transmission of the information, additional functions and applications such as, for example, for satellite navigation in the known GPS frequency range (1573 MHz) are also realized at times.

Contemporary telecommunication devices of this type are therefore to be in a position to be operated in as many of said frequency ranges as possible, so that corresponding dual or multiband antennas are necessary which cover these frequency ranges.

For the purpose of transmission and reception the antennas have to have electromagnetic resonances at the respective frequencies. To minimize the size of the antenna for a given wavelength, generally a dielectric having a dielectric constant εᵣ>1 is used as a basic module of the antenna. This leads to a shortening of the wavelength of the radiation in the dielectric by a factor 1/\sqrt{εᵣ}. An antenna designed on the basis of such a dielectric therefore becomes smaller by this factor.

An antenna of this type thus comprises a block (substrate) of dielectric material. On at least one of the surfaces of the substrate are deposited one or various metallizing structures depending on the desired operating frequency band or bands. The position or the resonant frequencies depend on the dimensions and the arrangement of the printed metallization structure and also on the value of the dielectric constant of the substrate. The individual resonance frequencies then shift to lower frequencies as the values of the dielectric constant rise.

In DE 10049845 is described a microwave antenna having a dielectric substrate and at least one resonant printed wiring structure which is characterized in by a plurality of line sections. The line sections have in essence a meander form on various side surfaces of the substrate. Such antennas can be welded on a printed circuit board together with other components via customary surface mounting. The bandwidth of such a known antenna is only sufficient to achieve a complete covering of the frequency bands of the GSM standard. The multiband applications mentioned in the opening paragraph are thus not possible.

It is an object of the invention to provide an antenna for said multiband applications.

The object is achieved by an antenna of the type defined in the opening paragraph in that the substrate on one end face has a first printed wiring structure along a first edge and a second printed wiring structure on an opposite, second edge of the same end face.

In addition to the advantage of the possibility of surface mounting (SMD), the antenna has the considerable advantage that the antenna can be used in the frequency ranges of the UMTS and Bluetooth standards. A particular advantage of the antenna is that the bandwidth of the antenna despite its small size is more than 1 GHz. A further considerable advantage is that the resonant metallization structures can completely be deposited on only one of the end faces of the substrate and thus the complete metallization structure can be manufactured in one manufacturing step.

The second printed wiring structure of the antenna is equal to the first printed wiring structure as regards shape and size. The substrate of the antenna is, in essence, oblong with two larger end faces and four smaller side faces. The first and second printed wiring structures are deposited on a first end face and stretch out from a first to a second, opposite side face along the edge.

The first and second printed wiring structure have the form of a rectangular face.

Each printed wiring structure may also be subdivided into four printed wires, a first printed wire extending from the first to the second side face along the edge, a second printed wire extending from the second to the first side face, a third printed wire extending to the first printed wire and the first printed wire connecting to the second printed wire. A fourth printed wire then connects to the second printed wire.

In this further embodiment the antenna can be operated in the frequency ranges of the GPS, DCS, UMTS and Bluetooth band.

The first and second printed wires as well as the third and fourth printed wires of the antenna are about equally long. At the same time the first and second printed wires are longer than the third and fourth printed wires. The fourth printed wire runs along an edge of the first end face. The first and third printed wires run perpendicular to the second and fourth printed wires. The two printed wiring structures are mirrored on the first end face.

The invention also relates to a printed wiring board on which an antenna according to the invention is mounted, as well as a radio communications device, more particularly for the GPS, DCS, UMTS and Bluetooth range with an antenna according to the invention.

These and other aspects of the invention are apparent from and will be elucidated, by way of non-limitative example, with reference to the embodiment(s) described hereinafter.

In the drawings:

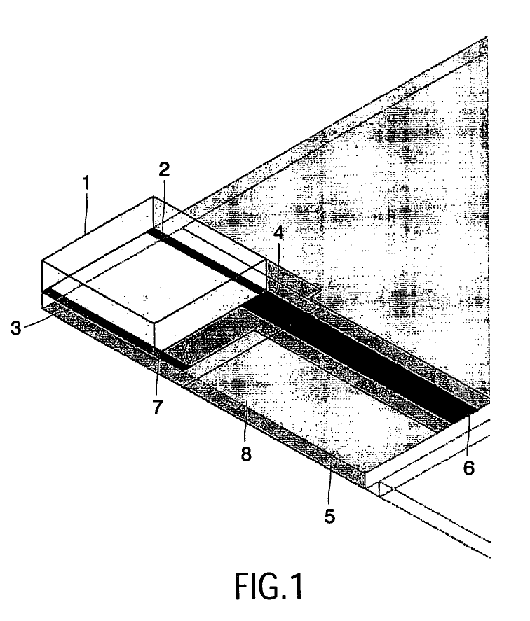

FIG. 1 gives a diagrammatic representation of a first antenna according to the invention;

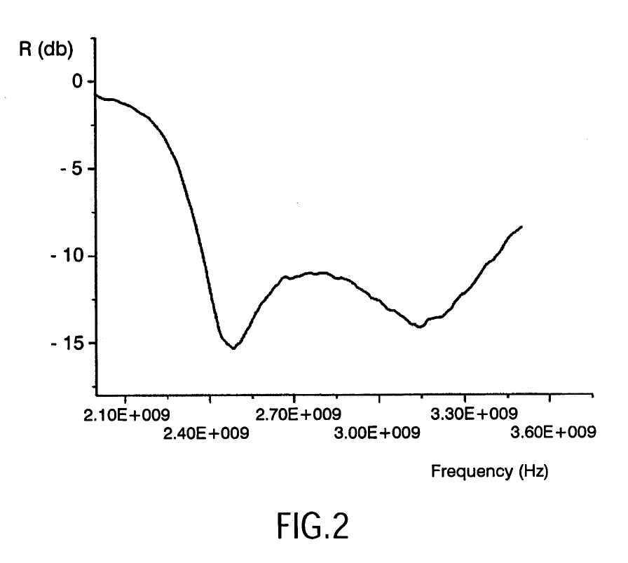

FIG. 2 a reflection diagram measured at the first antenna;

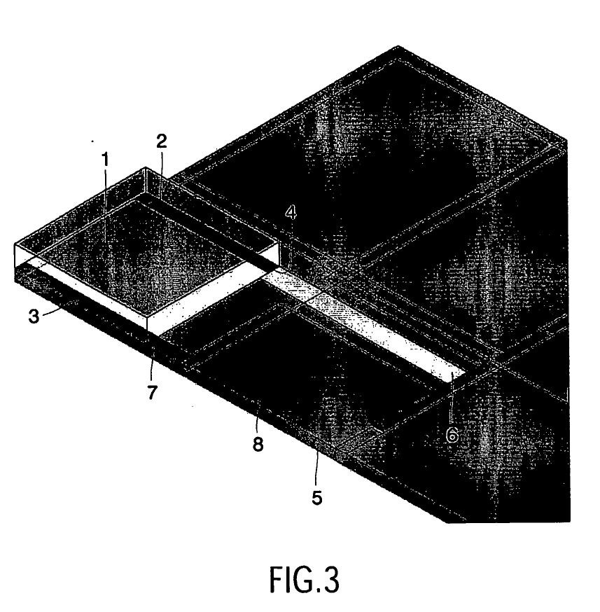

FIG. 3 a diagrammatic representation of a second antenna according to the invention;

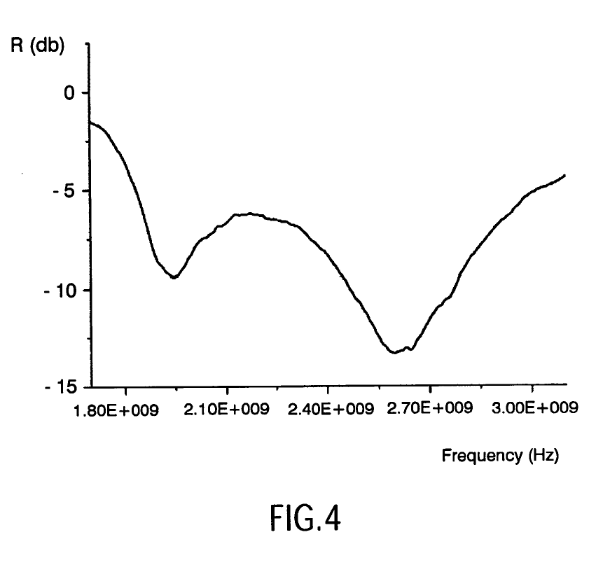

FIG. 4 a reflection diagram measured on the second antenna;

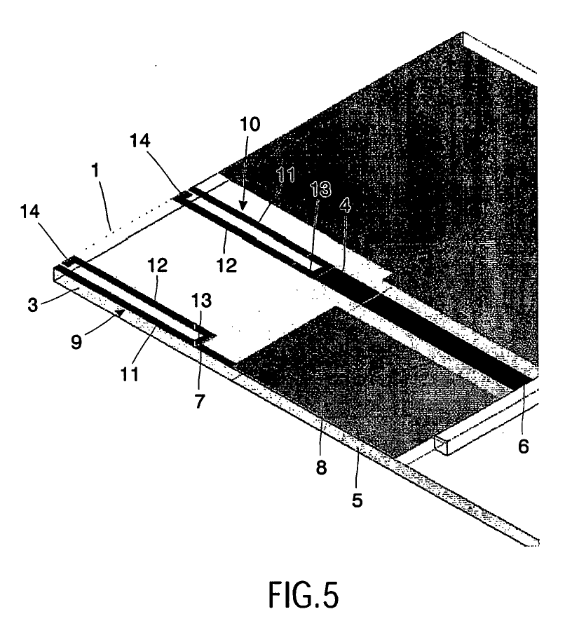

FIG. 5 a diagrammatic representation of a third antenna according to the invention; and

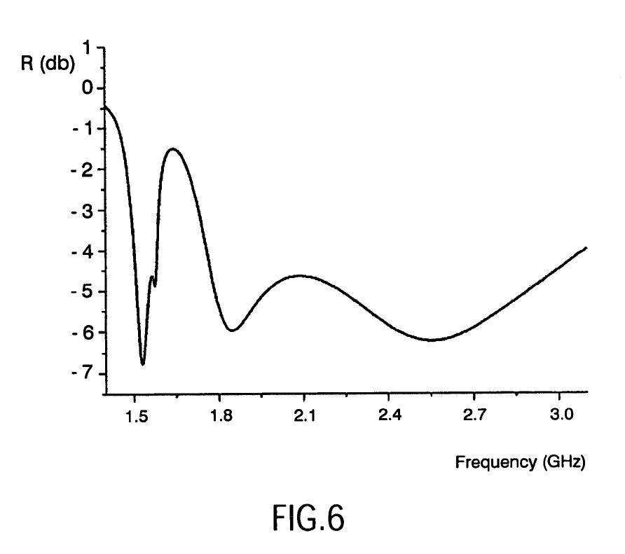

FIG. 6 a reflection diagram measured on the third antenna.

The embodiments to be described hereinafter have a substrate in the form of an in essence rectangular block whose height is about a factor of 3 to 10 smaller than its length or width. On the basis of this, the respective upper or lower (large) faces of the substrate in the representations of the Figures are referred to as upper or lower end faces respectively and the faces perpendicular thereto are referred to as side faces in the following description.

As an alternative, it is also possible to choose instead of a rectangular substrate other geometric forms such as, for example, a cylinder form on which a respective resonant printed wiring structure with a, for example, helical pattern is deposited.

The substrates can be manufactured by embedding a ceramic powder in a polymer matrix and have a relative permittivity of εᵣ>1 and/or a permeability of μᵣ>1.

The first antenna shown in FIG. 1 comprises a dielectric substrate 1 on whose lower end face are deposited two printed wiring structures 2 and 3. The printed wiring structure 2 will be supplied with power via a first supply 4, on the other hand, the printed wiring structure 3 is connected to a second supply 7. The substrate 1 is welded on a printed circuit board (PCB) 5 by surface mounting (SMD). This is effected by a flat welding in which several welding points not shown here (so-called footprints) and the supply 4 are connected to the board. The supply 4 is then brought into contact with a printed wire 6 on the board 5 via which radiating electromagnetic energy is supplied as a signal. The supply 7, on the other hand, is connected to a ground metallization 8 of the circuit board 5.

The two printed wiring structures 2 and 3 are arranged symmetrically on the lower end face of the substrate 1. Each printed wiring structure of the first antenna comprises a single printed wire which is impressed on the substrate 1 and runs parallel along the length of the lower end face from one side face to a second, opposite side face of the substrate 1.

The resonant frequencies of this antenna may be set in known fashion over the length and width as well as the distance of the impressed printed wiring structure. Superpositioning of the resonant frequencies caused by the printed wiring structures results in a bandwidth which enables the antenna to be operated at the desired frequencies.

For a possible production of this first antenna the dimensions of the substrate 1 are about 8×8×2.0 mm³. The material selected for the substrate 1 has a relative permittivity of εᵣ=21.5 and a tan δ=1.17×10⁻⁴. This about corresponds to the HF properties of a commercial NP0-K21 ceramic (Ca_{0.05}MG_{0.95}TiO₃ ceramic). The printed wire was manufactured by means of silver paste. The width of the line section is about 0.5 mm.

FIG. 2 shows the ratio R measured on the supply 4 of this antenna between the power reflected by the antenna and the power supplied to the antenna (reflection coefficient) plotted against frequency f in Hz. It may be clearly noticed that one of the two resonances covers the frequency range of the Bluetooth band from 2400-2483.5 MHz. The read bandwidth of over 1 GHz is sufficient to be able to effectively work within the frequency band. A further resonance is found at about 3100 MHz.

In addition to the advantage of the possibility of surface mounting (SMD) which holds for all embodiments, this embodiment has the considerable advantage that the antenna can be operated in the frequencies of the Bluetooth band. A further considerable advantage consists in that the resonant metallization structures 2 and 3 can be completely deposited on only one of the end faces of the substrate 1 and thus the manufacture of the complete metallization structures 2 and 3 can be integrated in one manufacturing step.

FIG. 3 shows a second embodiment of the invention. In this representation like or corresponding elements and components to those shown in FIG. 1 are referred to by like reference characters. As far as this is concerned, the description is referred to in conjunction with FIG. 1 and hereinafter only the differences will be explained.

With a production of this second antenna the dimensions of the substrate 1 are about 12×12×2.0 mm³. The material chosen for the substrate 1 is also an NP0-K21 ceramic having a relative permittivity of εᵣ=21.5 and a tan δ=1.17×10⁴. Printed wires were also manufactured with silver paste. The width of the printed wires was changed by about 1.0 mm.

The advantages of the second embodiment consist of the integration of the manufacturing of the metallization structure in one step as well as the possibility of surface mounting. This antenna, however, has the substantial advantage that it can be operated at the frequencies of the UMTS and Bluetooth standard.

FIG. 4 shows the ratio R measured at the supply 4 of this antenna between the power reflected by the antenna and the power supplied to the antenna (reflection coefficient) plotted against frequency f in Hz. Two resonant frequencies may clearly be read at about 1.95 GHz and 2.6 GHz. The bandwidth of the second antenna is much beyond 1 GHz, so that frequencies both in the UMTS as well as Bluetooth band can be covered.

FIG. 5 shows a third embodiment of the invention. The third antenna also comprises a dielectric substrate 1 on whose lower end face the two printed wiring structures 2 and 3 are deposited. The essential difference between the printed wires 2 and 3 and the first antenna lies in the form of the printed wires. Furthermore, the printed wiring structure 2 will be supplied with power via a first supply 4, on the other hand, the printed wiring structure 3 is connected to a second supply 7. The same or corresponding elements and components of the antenna shown in FIG. 5 are referred to by the same reference characters used in FIG. 1. As far as this is concerned, the description relating to FIG. 1 is referred to and only the differences will be explained hereinafter.

The metal structures 2 and 3 are formed not only by a first printed wire 11 which runs along the length of the lower end face from the first side face to the second, opposite face of the substrate 1, but also by a second, inner printed wire 12 which runs parallel to the first printed wire 11 at a distance of about 0.8 mm.

The two parallel printed wires 11 and 12 are connected by a third printed wire 13 running perpendicularly to the printed wires 11 and 12 along the second side face. A fourth printed wire 14 also runs perpendicular to the printed wires 11 and 12 and is connected to the printed wire 12. It stretches out along the first side face of the substrate 11 in the direction of the printed wire 11. Different from the printed wire 13, the printed wire 14 does not connect the parallel printed wires 11 and 12. Printed wires 11 to 14 together form the metal structure 9 or 10, respectively.

The dimensions of the substrate 1 of the third antenna are about 12×12×2.0 mm³. The material selected for the substrate 1 also comprises an NP0-K21 ceramic having a relative permittivity εᵣ=21.5 and a tan δ=1.17×10⁻⁴. Printed wires were also produced by means of silver paste. The width of the printed wires 11 to 14 was changed to about 0.5 mm.

A special advantage of this embodiment is thus in addition to the advantages mentioned above that with this antenna multiband operation of a respective mobile radio is possible.

FIG. 6 shows the ratio R between the power reflected by the antenna and the power applied to the antenna (reflection coefficient) measured at the supply 4 of the third antenna plotted against frequency f in GHz. Three resonant frequencies at 1.57 GHz, 1.85 GHz and 2.55 GHz and a bandwidth of the antenna of about 1.2 GHz can clearly be recognized. The condition of the resonances makes it possible to utilize the proposed antennas in the four separate applications GPS, DCS/PCS, UMTS and Bluetooth.

1. An antenna having a dielectric substrate (1) and two resonant printed wiring structures, more particularly for use in high-frequency and microwave range, a first printed wiring structure (2) being arranged on one end face of the substrate (1) along a first edge and a second printed wiring structure (3) on an opposite, second edge of the same end face.

2. An antenna as claimed in claim 1, characterized in that the second printed wiring structure (3) is equal to the first printed wiring structure (2) as regards shape and size.

3. An antenna as claimed in claim 1, characterized in that the substrate (1) is in essence rectangular having two larger end faces and four smaller end faces and in that the first and second printed wiring structures (2, 3) are deposited on a first end face and stretch out from a first to a second, opposite side face along the edge.

4. An antenna as claimed in claim 1, characterized in that the first and second printed wiring structures (2, 3) have the form of a rectangular face.

5. An antenna as claimed in claim 3, characterized in that each printed wiring structure (2, 3) is subdivided into three printed wires (11 to 13) where
a first printed wire (11) stretches out from the first to the second side face along the edge, and
a second printed wire (12) stretches out from the second to the first end face,
a third printed wire (13) is connected to the first printed wire and the first printed wire is connected to the second printed wire.

6. An antenna as claimed in claim 5, characterized in that a fourth printed wire (14) is connected to the second printed wire (12).

7. An antenna as claimed in claim 5, characterized in that the first and second printed wires (11, 12) are equally long.

8. An antenna as claimed in claim 5, characterized in that the third and fourth printed wires (13, 14) are equally long.

9. An antenna as claimed in claim 5, characterized in that the first and second printed wires (11, 12) are longer than the third and fourth printed wires (13, 14).

10. An antenna as claimed in claim 5, characterized in that the fourth printed wire (14) runs along an edge of the first end face.

11. An antenna as claimed in claim 5, characterized in that the first and third printed wires are arranged perpendicular to the second and fourth printed wires.

12. An antenna as claimed in claim 2, characterized in that the second printed wiring structures (2, 3) are mirrored on the first end face.

13. A printed wiring board on which an antenna as defined in claim 1 is arranged.

14. A radio communication device, more particularly for the GPS, DCS/PCS, UMTS and Bluetooth domain, characterized by an antenna as claimed in claim 1.
